(19) United States
(12) Patent Application Publication
(10) Pub. No.: US 2004/0190771 A1
(43) Pub. Date: Sep. 30, 2004

(54) Integer format for efficient image data processing

(76) Inventors: Michel Eid, Montreal (CA); Shailendra Mathur, Beaconsfield (CA); David MacDonald, Montreal (CA)

Correspondence Address: PETER J. GORDON, PATENT COUNSEL, AVID TECHNOLOGY, INC., ONE PARK WEST, TEWKSBURY, MA, 01876, US

(21) Appl. No.: 10/400,974

(22) Filed: Mar. 27, 2003

(51) Int. Cl. H04N 1/56; H04N 1/60; G09G 5/02

(52) U.S. Cl. 382/167; 345/590; 345/600

(57) ABSTRACT

A fixed point integer color component representation has been defined that provides accuracy and computational speed similar to an integer format, but has a range that supports super-black and super-white values. This color component representation uses m bits, with an n-bit integer part and a k-bit fractional part. The m-bit integer represents a range of values having a minimum value less than zero and a maximum value greater than one. A value of zero represents the black point of the color gamut whereas a value of one represents the white point of the color gamut. The range of values includes values between zero and one correspond to legal values in the color gamut. Values less than zero represent super black values. Values greater than one represent super white values. To achieve this, m should be greater than or equal to three and n should be greater than or equal to two. In a particular implementation, this representation uses 16 bits to define a signed 2-bit integer with a 14-bit fractional part. This representation allows the preservation of the full color gamut of different color spaces, such as YCbCr and RGB. It includes enough room below the black-point and about the white-point in different color spaces to avoid clamping during typical image processing tasks.

### BACKGROUND

Image data has multiple sampling resolutions. There is a temporal sampling rate, commonly called the frame rate, of motion picture data. Each image also has a vertical and horizontal sampling resolution indicating the number of individual elements, commonly called pixels, in the horizontal and vertical dimensions of the image. Each pixel typically is represented by a number of components to define a color. The components may represent luminance and chrominance (YCrCb, for example), or may represent color channels (red, green and blue, for example). A value for each component generally is represented using a number of bits called the bit depth. Typical bit depths used for images are eight bits, ten bits and sixteen bits.

The bit depth used to represent the values for each pixel affects the accuracy of results from image processing operations. To provide better accuracy, several image processing tools use 16-bit integers, 16-bit floating point values or even 32-bit floating point values to represent the components of a pixel. The use of 8-bit integers and 16-bit integers, on the other hand, improves computation speed because integer arithmetic is less complex than floating point arithmetic.

A problem with using a 16-bit integer representation, as used by most image processing tools, does not allow for enough room above and below the legal range of a color space. Values that are out of the legal range need to be preserved between consecutive image processing routines. Because these values are “blacker than black” or “whiter than white”, they are typically referred to as “Super-black” and “Super-white” values.

A 16-bit floating point representation for color components, called OpenEXR, has been developed to address this need to handle out of range values. This representation includes a “half” format that are a floating point representation with 1 sign bit, 5 exponent bits and 10 mantissa bits. Because this representation is a floating point representation, it uses more computational resources than an integer format.

### SUMMARY

A fixed point integer color component representation has been defined that provides accuracy and computational speed similar to an integer format, but has a range that supports super-black and super-white values. This color component representation uses m bits, with an n-bit integer part and a k-bit fractional part. The m-bit integer represents a range of values having a minimum value less than zero and a maximum value greater than one. A value of zero represents the black point of the color gamut whereas a value of one represents the white point of the color gamut. The range of values between zero and one corresponds to legal values in the color gamut. Values less than zero represent super black values. Values greater than one represent super white values. These characteristics are achieved, for example, if m is greater than or equal to three and n is greater than or equal to two.

In a particular implementation, this representation uses 16 bits to define a signed 2-bit integer with a 14-bit fractional part. This representation allows the preservation of the full color gamut of different color spaces, such as YCbCr and RGB. It includes enough room below the black-point and about the white-point in different color spaces to avoid clamping during typical image processing tasks.

Accordingly, in one aspect, a computer information product for representing color images comprises a computer readable memory and data stored in the computer readable memory. When interpreted by a computer, the data defines a plurality of components for a plurality of pixels in an image, including, for each component, a signed m-bit integer including n most significant bits representing a signed integer part and k least significant bits representing a fractional part.

The signed m-bit integer represents a range of values having a minimum value less than zero and a maximum value greater than one. The range of values includes values between zero and one that correspond to legal values in a gamut of a color space, and includes values less than zero that represent super black values and values greater than one that represent super white values. Generally, m is greater than or equal to three and n is greater than or equal to two.

In another aspect, a method and computer program product for processing image data involves receiving image data using a first representation for each color component. The received image data is converted into image data using a second representation for each color component. The second representation of each color component includes for each component, a signed m-bit integer including n most significant bits representing a signed integer part and k least significant bits representing a fractional part.

In another aspect, a method and computer program product for processing image data involves receiving image data using a first representation for each color component. The first representation of each color component includes for each component, a signed m-bit integer including n most significant bits representing a signed integer part and k least significant bits representing a fractional part. Received image data in this first representation is converted into image data in a second representation.

In another aspect, a method and computer program product for processing image data involves receiving image data using an integer representation for each color component,. The integer representation of each color component includes for each component, a signed m-bit integer including n most significant bits representing a signed integer part and k least significant bits representing a fractional part. Image processing operations are performed on the image data to provide processed image data in the integer representation.

### BRIEF DESCRIPTION OF THE DRAWINGS

FIG. 1 is a description of a representation of a color component using a signed 2-bit integer and a 14-bit fractional part.

FIG. 2 is a data flow diagram of an example image processing system using the representation of FIG. 1.

### DETAILED DESCRIPTION

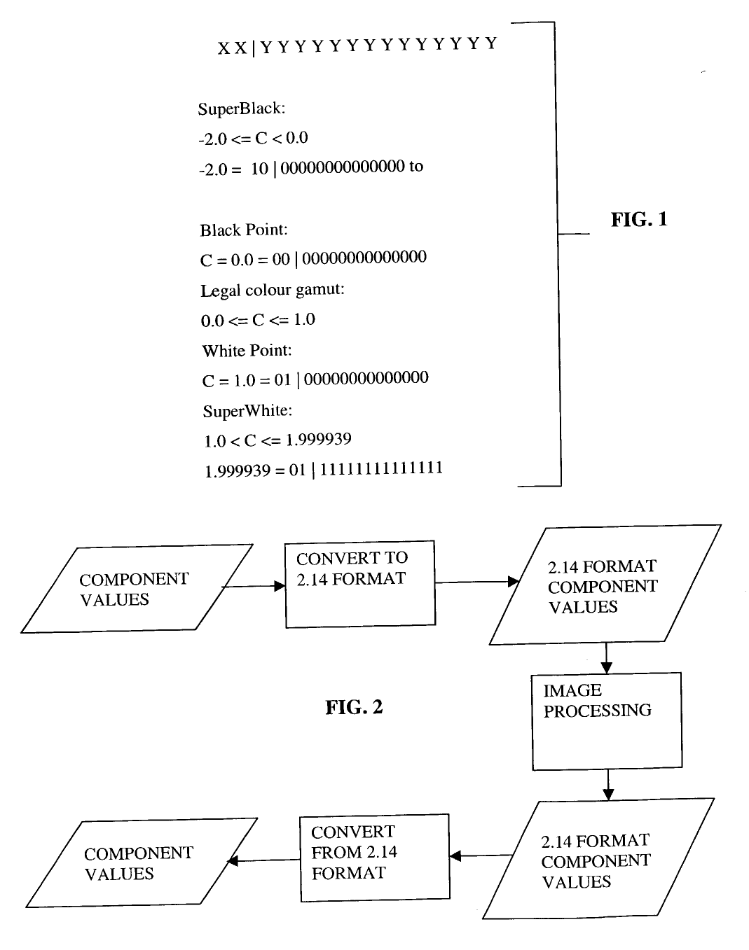

A fixed point integer color component representation has been defined that provides accuracy and computational speed similar to an integer format, but has a range that supports super-black and super-white values. An m-bit integer has an n-bit integer part and a k-bit fractional part. Referring to FIG. 1, an example of this type representation uses 16 bits to define a signed 2-bit integer “XX” with a 14-bit fractional part indicated by Y's. This representation, called a “2.14” representation or format herein, allows the preservation of the full color gamut of different color spaces, such as YCbCr and RGB. It includes enough room below the black-point and about the white-point in different color spaces to avoid clamping during typical image processing tasks.

As shown in FIG. 1, this color component representation is a normalized representation with the following distribution over the color gamut. FIG. 1 illustrates the corresponding 2.14 format value for the endpoints of the SuperBlack range, the legal color gamut and the SuperWhite range. The SuperBlack footroom is defined by values −2.0 to 0.0, the legal color gamut is defined by values 0.0 to 1.0 and the SuperWhite headroom is defined by values 1.0 to 1.999939. The black point and the white point of the color gamut are represented by 0.0 and 1.0 respectively.

Referring now to FIG. 2, a data flow diagram of an example image processing system 200 using this format will now be described. The image processing system 200 processes image data that represents a plurality of pixels. Each pixel is defined by several color components, such as RGB or YCrCb. Component values for a pixel 202 are received by a conversion module 204. The component values are represented using a first representation, such as 10-bit integer, 16-bit integer or a floating point format (e.g., 16-bit, 32-bit or 64-bit). The conversion module 204 converts the received component values into image data 206 using the 2.14 representation for each color component.

In general such a conversion is performed by normalizing the color component value and representing this normalized value in the 2.14 representation. The normalization is such that a black point maps to zero in the 2.14 representation and a white point maps to one in the 2.14 representation. For example, using a 10-bit value for a component, the 10-bit value may be shifted into a 16-bit register to provide a 16-bit value. Example equations describing how to convert the 16-bit value for Y (Y10.6), C (C10.6) and alpha (Alpha16) components into a 2.14 representation (Y2.14, C2.14 and Alpha2.14) are the following:

Y2.14=(Y10.6−(16<<8))*16384.0/(219<<8)

C2.14=(C10.6−(128<<8))*16384.0/(224<<8)

Alpha2.14 =Alpha16*16384.0/65535.0

The 2.14 format component values 206 then may be processed by an image processing operations 208 using integer arithmetic. For example, such image processing operations may include, but are not limited to, operations to combine images, such as compositing, blending and keying, or operations within an image, such as resizing, filtering and color correction, or operations between two images, such as motion estimation. The results of such image processing operations also may be image data with component values in the 2.14 format, as shown at 210.

Although FIG. 2 shows only one image processing operation, there may be multiple image processing operations that may operate in parallel on the data or may operate as a sequence of operations. There are a variety of ways in which an image processing operation may access the data in the 2.14 format, and the invention is not limited thereby. As an example, the conversion module and the image processing operation may be part of a larger application for editing video information and may access the image data in the same buffer in memory. As another example, the image processing operation may be part of a plug-in to an editing application that permits access to the memory through an application programming interface (API). As another example, the image processing operation may access or may be sent a data file that includes the image data in the 2.14 format.

Using this 2.14 representation of color components, all mathematical operations may be performed using 16-bit integer operations. Because the black point corresponds to an integer value of 0 and the white point corresponds to a power of 2 (16384), the mathematics of blending and compositing are more efficient to implement than if the mapping were otherwise.

The processed component values in the 2.14 format 210 may be received by a conversion module 212. The conversion module 212 converts the received component values in the 2.14 format into image data 214 using another representation for each color component. For example, the component values may be converted to another representation, such as 10-bit integer, 16-bit integer or a floating point format (e.g., 16-bit, 32-bit or 64-bit). The format of the output data 214 may be the same as or different from the format of the input data 202.

To convert a value in the 2.14 representation to another format involves converting the normalized value in the 2.14 format to its corresponding value in the other format. Thus, a zero in the 2.14 representation corresponds to a black point in the other format and one in the 2.14 representation corresponds to a white point in the other format.

As an example, to convert a component value in the 2.14 representation to a 10-bit integer value, the value is first transformed into a 16-bit value using floating point arithmetic, followed by rounding to obtain a 16-bit integer. The 16-bit integer then is shifted by 6 bits to obtain a 10-bit value. Values for alpha components generally are retained in a 16-bit format. Example equations for performing the conversion of Y (Y2.14), C (C2.14) and alpha (Alpha2.14) values from a 2.14 representation to a 10-bit representation (Y10, C10) with a 16-bit alpha channel (Alpha 16) are the following:

Y10.6=(16 <<8)+(219<<8)* Y2.14/16384.0

Y10=Y10.6 >>6

C10.6=(128<<8)+(224<<8)*C2.14/16384.0

C10=C10.6>>6

Alpha16=Alpha2.14*65535.0/16384.0

The foregoing examples illustrate how data in an example format (2.14) may be processed. The invention is not limited to using this example format. Other signed integer formats using an integer part and a fractional part also may be used.

The various components of the system shown in FIG. 2 may be implemented as a computer program using a general-purpose computer system. Such a computer system typically includes a main unit connected to both an output device that displays information to a user and an input device that receives input from a user. The main unit generally includes a processor connected to a memory system via an interconnection mechanism. The input device and output device also are connected to the processor and memory system via the interconnection mechanism.

One or more output devices may be connected to the computer system. Example output devices include, but are not limited to, a cathode ray tube (CRT) display, liquid crystal displays (LCD) and other video output devices, printers, communication devices such as a modem, and storage devices such as disk or tape. One or more input devices may be connected to the computer system. Example input devices include, but are not limited to, a keyboard, keypad, track ball, mouse, pen and tablet, communication device, and data input devices. The invention is not limited to the particular input or output devices used in combination with the computer system or to those described herein.

The computer system may be a general purpose computer system which is programmable using a computer programming language, such as “C++,” Visual Basic, JAVA or other language, such as a scripting language or even assembly language. The computer system may also be specially programmed, special purpose hardware. In a general-purpose computer system, the processor is typically a commercially available processor, such as various processors available from Intel, AMD, Cyrix, Motorola, and IBM. The general-purpose computer also typically has an operating system, which controls the execution of other computer programs and provides scheduling, debugging, input/output control, accounting, compilation, storage assignment, data management and memory management, and communication control and related services. Example operating systems include, but are not limited to, the UNIX operating system and those available from Microsoft and Apple Computer.

A memory system typically includes a computer readable medium. The medium may be volatile or nonvolatile, writeable or nonwriteable, and/or rewriteable or not rewriteable. A memory system stores data typically in binary form. Such data may define an application program to be executed by the microprocessor, or information stored on the disk to be processed by the application program. The invention is not limited to a particular memory system.

A system such as described in FIG. 2 may be implemented in software or hardware or firmware, or a combination of the three. The various elements of the system, either individually or in combination may be implemented as one or more computer program products in which computer program instructions are stored on a computer readable medium for execution by a computer. Various steps of a process may be performed by a computer executing such computer program instructions. The computer system may be a multiprocessor computer system or may include multiple computers connected over a computer network. The components shown in FIG. 1 may be separate modules of a computer program, or may be separate computer programs, which may be operable on separate computers. The data produced by these components may be stored in a memory system or transmitted between computer systems.

Having now described an example embodiment, it should be apparent to those skilled in the art that the foregoing is merely illustrative and not limiting, having been presented by way of example only. Numerous modifications are within the capabilities of one of ordinary skill in the art and are contemplated as falling within the scope of the invention.

What is claimed is:

1. A computer information product for representing color images, comprising:
a computer readable memory; and
data stored in the computer readable memory that when interpreted by the computer defines a plurality of components for a plurality of pixels in an image, including, for each component, a signed m-bit integer including n most significant bits representing a signed integer part and k least significant bits representing a fractional part, wherein the signed m-bit integer represents a range of values having a minimum value less than zero and a maximum value greater than one, wherein the range of values includes values between zero and one that correspond to legal values in a gamut of a color space, and includes values less than zero that represent super black values and values greater than one that represent super white values, wherein m is greater than or equal to three and n is greater than or equal to two.

2. A method for processing image data, comprising:
receiving image data using a first representation for each color component; and
converting the received image data into image data using a second representation for each color component, wherein the second representation of each color component includes for each component, a signed m-bit integer including n most significant bits representing a signed integer part and k least significant bits representing a fractional part.

3. The method of claim 2, wherein converting comprises:
normalizing the value using the first representation, wherein zero represents a black point and one represents a white point; and
representing the normalized value using the second representation.

4. The method of claim 2, wherein the first representation for each color component is a 10-bit integer.

5. The method of claim 2, wherein the first representation for each color component is a 16-bit integer.

6. The method of claim 2, wherein the first representation for each color component is a 16-bit floating point value.

7. The method of claim 2, wherein the first representation for each color component is a 32-bit floating point value.

8. The method of claim 2, wherein the first representation for each color component is a 64-bit floating point value.

9. A computer program product comprising:
a computer readable medium;
computer program instructions stored on the computer readable medium that, when executed by a computer, instruct the computer to perform a method for processing image data, comprising:
receiving image data using a first representation for each color component; and
converting the received image data into image data using a second representation for each color component, wherein the second representation of each color component includes for each component, a signed m-bit integer including n most significant bits representing a signed integer part and k least significant bits representing a fractional part.

10. The computer program product of claim 9, wherein converting comprises:
normalizing the value in the first representation, wherein zero represents a black point and one represents a white point; and
representing the normalized value using the second representation.

11. A method for processing image data, comprising:
receiving image data using a first representation for each color component, wherein the first representation of each color component includes for each component, a signed m-bit integer including n most significant bits representing a signed integer part and k least significant bits representing a fractional part
converting the received image data into a second representation.

12. The method of claim 11, wherein converting comprises:
computing a value in the second representation from the value in the first representation such that zero in the first representation corresponds to a black point in the second representation and one in the first representation corresponds to a white point in the second representation.

13. The method of claim 11, wherein the second representation for each color component is a 10-bit integer.

14. The method of claim 11, wherein the second representation for each color component is a 16-bit integer.

15. The method of claim 11, wherein the second representation for each color component is a 16-bit floating point value.

16. The method of claim 11, wherein the second representation for each color component is a 32-bit floating point value.

17. The method of claim 11, wherein the second representation for each color component is a 64-bit floating point value.

18. A computer program product comprising:
a computer readable medium;
computer program instructions stored on the computer readable medium that, when executed by a computer, instruct the computer to perform a method for processing image data, comprising:
receiving image data using a first representation for each color component, wherein the first representation of each color component includes for each component, a signed m-bit integer including n most significant bits representing a signed integer part and k least significant bits representing a fractional part
converting the received image data into a second representation.

19. The computer program product of claim 18, wherein converting comprises:
computing a value in the second representation from the value in the first representation such that zero in the first representation corresponds to a black point in the second representation and one in the first representation corresponds to a white point in the second representation.

20. A method for processing image data, comprising:
receiving image data using an integer representation for each color component, wherein the integer representation of each color component includes for each component, a signed m-bit integer including n most significant bits representing a signed integer part and k least significant bits representing a fractional part; and
performing image processing operations on the image data to provide processed image data in the integer representation.

21. The method of claim 20, further comprising:
converting the processed image data into image data using a different representation for each color component.

22. The method of claim 21, wherein converting the processed image data into image data using the different representation for each color component, comprises:

23. The method of claim 22, further comprising:
receiving image data using a first representation different from the integer representation of each color component; and
converting the received image data into image data using the integer representation for each color component.

24. The method of claim 23, wherein converting the received image data into image data using the integer representation for each color component, comprises:

25. The method of claim 20, further comprising:
receiving image data using a first representation different from the integer representation of each color component; and
converting the received image data into image data using the integer representation for each color component.

26. The method of claim 25, wherein converting the received image data into image data using the integer representation for each color component, comprises:

27. A computer program product comprising:
a computer readable medium;
computer program instructions stored on the computer readable medium that, when executed by a computer, instruct the computer to perform a method for processing image data, comprising:
receiving image data using an integer representation for each color component, wherein the integer representation of each color component includes for each component, a signed m-bit integer including n most significant bits representing a signed integer part and k least significant bits representing a fractional part; and
performing image processing operations on the image data to provide processed image data in the integer representation.

28. A computer information product for representing color images, comprising:
a computer readable memory; and
data stored in the computer readable memory that when interpreted by the computer defines a plurality of components for a plurality of pixels in an image, including, for each component, a signed 16-bit integer including two most significant bits representing a signed integer part and fourteen least significant bits representing a fractional part.
